(19) United States
(12) Patent Application Publication
(10) Pub. No.: US 2025/0329953 A1
(43) Pub. Date: Oct. 23, 2025

(54) ELECTRICAL CONNECTION DEVICE

(71) Applicant: Bellwether Electronic Corp., Taoyuan City (TW)

(72) Inventor: Jimmy Enrique ACERA, Taoyuan City (TW)

(21) Appl. No.: 19/089,009

(22) Filed: Mar. 25, 2025

Related U.S. Application Data
(60) Provisional application No. 63/636,113, filed on Apr. 19, 2024.

(30) Foreign Application Priority Data
Jan. 20, 2025 (TW) 114102303

(51) Int. Cl. H01R 13/187

(52) U.S. Cl. CPC H01R 13/187

(57) ABSTRACT

An electrical connection device includes a housing, a connecting socket, a conducting contact element, an elastic element, and an engaging element. The housing has a bottom portion, a top portion, and a side portion. The bottom portion has an opening configured for an electrical connecting terminal to pass through. The connecting socket is coupled to the housing. The connecting socket has a mating portion and a connecting portion connected to each other. The mating portion is in the housing and has a mating hole. The mating hole is interconnected to the opening. The conducting contact element is in the mating hole. The elastic element is between the mating portion and the side portion. The engaging element is coupled to the housing and configured to insert into a notch of the electrical connecting terminal.

### CROSS-REFERENCE TO RELATED APPLICATION

This application claims priority to U.S. Provisional Application Ser. No. 63/636,113 filed Apr. 19, 2024, and Taiwan Application Serial Number 114102303, filed Jan. 20, 2025, which is herein incorporated by reference in its entirety.

### BACKGROUND

### Field of Disclosure

The present disclosure relates to an electrical connection device. More particularly, the present disclosure relates to an electrical connection device for high current power transmission.

### Description of Related Art

In large power systems such as electric vehicle charging systems, a large number of high current power connectors are often required to electrically connect wires and cables to electrical connecting terminals of printed circuit boards (PCBs) to transmit power. In order to allow users to flexibly adjust layouts of printed circuit boards according to specific applications and reduce installation and maintenance costs, an electrical connection device that is easy for mating and un-mating is needed.

### SUMMARY

An aspect of the disclosure is to provide an electrical connection device that may efficiently solve the aforementioned problems.

According to an embodiment of the disclosure, an electrical connection device includes a housing, a connecting socket, a conducting contact element, an elastic element, and an engaging element. The housing has a bottom portion, a top portion, and a side portion. The side portion connects the bottom portion and the top portion. The bottom portion has an opening configured for an electrical connecting terminal to pass through. The connecting socket is coupled to the housing. The connecting socket has a mating portion and a connecting portion connected to each other. The mating portion is in the housing and has a mating hole. The mating hole is interconnected to the opening of the bottom portion of the housing. The conducting contact element is in the mating hole of the connecting socket. The elastic element is between the mating portion of the connecting socket and the side portion of the housing. The engaging element is coupled to the housing and configured to insert into a notch of the electrical connecting terminal.

In an embodiment of the disclosure, the engaging element is at a side of the mating portion that is away from the elastic element.

In an embodiment of the disclosure, the engaging element is over the connecting socket.

In an embodiment of the disclosure, the connecting socket is over the engaging element.

In an embodiment of the disclosure, the elastic element is connected to the engaging element.

In an embodiment of the disclosure, the side portion of the housing has a protrusion. The protrusion protrudes toward the connecting socket. The protrusion is configured to abut against the elastic element when the engaging element inserts into the notch of the electrical connecting terminal.

In an embodiment of the disclosure, the elastic element has an engaging hole. The connecting socket has an engaging portion coupled to the engaging hole of the elastic element.

In an embodiment of the disclosure, the elastic element is configured to be compressed along a lengthwise direction of the connecting socket when the engaging element inserts into the notch of the electrical connecting terminal.

In an embodiment of the disclosure, a dimension of the electrical connecting terminal along the lengthwise direction is less than a dimension of the opening of the housing along the lengthwise direction.

In an embodiment of the disclosure, the connecting portion is configured for a cable to enter along the lengthwise direction and be electrically connected.

In an embodiment of the disclosure, the elastic element is configured to be compressed along a width direction of the connecting socket when the engaging element inserts into the notch of the electrical connecting terminal.

In an embodiment of the disclosure, the engaging element is a structure formed integrally with the housing.

According to another embodiment of the disclosure, an electrical connection device includes a housing, a connecting socket, a conducting contact element, and an engaging element. The housing has a bottom portion, a top portion, and a side portion. The side portion connects the bottom portion and the top portion. The bottom portion has an opening configured for an electrical connecting terminal to pass through. The connecting socket is coupled to the housing in a relatively movable manner. The connecting socket has a mating hole. The mating hole is interconnected to the opening of the bottom portion of the housing. The conducting contact element is in the mating hole of the connecting socket. The engaging element is coupled to the housing and configured to engage the electrical connecting terminal when the electrical connecting terminal inserts into the mating hole.

In an embodiment of the disclosure, the connecting socket includes a mating portion and a connecting portion. The mating portion is in the housing and connected to the connecting portion along a lengthwise direction of the connecting socket.

In an embodiment of the disclosure, the electrical connection device further includes an elastic element. The elastic element is between the mating portion and the side portion.

In an embodiment of the disclosure, the elastic element is connected to the engaging element. The side portion has a protrusion configured to abut against the elastic element.

In an embodiment of the disclosure, a dimension of the opening along the lengthwise direction is greater than a dimension of the opening along a direction that is perpendicular to the lengthwise direction.

In an embodiment of the disclosure, a dimension of the opening along the lengthwise direction is less than a dimension of the opening along a direction that is perpendicular to the lengthwise direction.

In an embodiment of the disclosure, in a projection along a central axis of the mating hole, the engaging element partially overlaps the opening.

Accordingly, in the electrical connection device of some embodiments of the present disclosure, the elastic element is disposed between the connecting socket and the housing along the lengthwise direction of the connecting socket, and the engaging element is in the housing and configured to insert into the notch of the electrical connecting terminal. Therefore, the electrical connection device and the electrical connecting terminal can be locked and unlocked by moving the housing of the electrical connection device relative to the electrical connecting terminal along the lengthwise direction of the connecting socket. Compared with common electrical connection devices, mating and assembly of the electrical connection device of some embodiments of the present disclosure are facilitated, reducing the time and labor consumed in installation and maintenance, which in turn reduces costs.

It is to be understood that both the foregoing general description and the following detailed description are by examples and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is an exploded view of an electrical connection device according to some embodiments of the present disclosure;

FIG. 2 is a perspective view of a first portion and an engaging element of an electrical connection device according to some embodiments of the present disclosure;

FIG. 3A, FIG. 3B, FIG. 3C, and FIG. 3D are cross-sectional views of an electrical connection device and an electrical connecting terminal according to some embodiments of the present disclosure;

FIG. 4 is an exploded view of an electrical connection device according to some embodiments of the present disclosure;

FIG. 5 is a perspective view of a second portion and an engaging element of an electrical connection device according to some embodiments of the present disclosure;

FIG. 6A and FIG. 6B are cross-sectional views of an electrical connection device and an electrical connecting terminal according to some embodiments of the present disclosure;

FIG. 7 is an exploded view of an electrical connection device according to some other embodiments of the present disclosure;

FIG. 8 is a perspective view of a first portion and an elastic piece of an electrical connection device according to some other embodiments of the present disclosure; and

FIG. 9A and FIG. 9B are cross-sectional views of an electrical connection device and an electrical connecting terminal according to some other embodiments of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts. However, specific structural and functional details disclosed herein are merely representative for purposes of describing example embodiments and thus may be embodied in many alternate forms and should not be construed as limited to only example embodiments set forth herein. Therefore, it should be understood that there is no intent to limit example embodiments to the particular forms disclosed, but on the contrary, example embodiments are to cover all modifications, equivalents, and alternatives falling within the scope of the disclosure.

In the drawings, thicknesses of layers, films, panels, regions, etc., are exaggerated for clarity. It should be understood that when an element such as a layer, a film, a region, or a substrate is described as being “on” or “connected to” another element, it can be directly on or connected to the other element, or intermediate elements may also be present. In contrast, when an element is described as being “directly on” or “directly connected to” another element, there are no intermediate elements present. As used herein, “connected” may refer to physical and/or electrical connections. Furthermore, “electrically connected” or “coupled” can indicate the presence of other elements between the two elements.

The terms used herein are merely for the purpose of describing specific embodiments and are not intended to be limiting. As used herein, the singular forms “a,” “an,” and “the” are intended to include the plural forms, including “at least one,” unless the context clearly indicates otherwise. “Or” indicates “and/or.” As used herein, the term “and/or” includes any and all combinations of one or more of the associated listed items. It should also be understood that when used in the specification, the terms “comprising” and/or “including” specify the presence of said features, regions, entities, steps, operations, elements and/or components, but do not exclude the presence or addition of one or more other features, regions, entities, steps, operations, elements, components, and/or combinations thereof.

Furthermore, spatially relative terms, such as “beneath,” “below,” “lower,” “above,” “over,” “upper,” and the like, may be used herein for ease of description to describe one element or feature's relationship to another element(s) or feature(s) as illustrated in the drawings. It should be understood that the spatially relative terms are intended to encompass different orientations of the device in use or operation in addition to the orientation depicted in the drawings. The device may be otherwise oriented (rotated 90 degrees or at other orientations) and the spatially relative descriptors used herein may likewise be interpreted accordingly.

The terms “about,” “approximately,” “substantially,” and the like as used herein are inclusive of the stated value and the average value within an acceptable deviation range determined by those skilled in the art, considering the measurement in question and the measurement-related errors of the particular quantity (i.e., the limitations of the measurement system). For example, “about” can indicate within one or more standard deviations, or within ±30%, ±20%, ±10%, or ±5% of the stated value. Furthermore, a relatively acceptable deviation range or standard deviation may be chosen for the terms “about,” “approximately,” “substantially,” and the like as used herein based on optical properties, etching properties, or other properties, rather than a single standard deviation applied to all properties.

Exemplary embodiments are described herein with reference to cross-sectional views that are schematic diagrams of idealized embodiments. As such, variations in the shapes of the illustrations may be expected, for example, as a result of manufacturing techniques and/or tolerances. Accordingly, the embodiments described in this disclosure should not be construed as limited to the specific shapes of regions as illustrated herein, but should include deviations in shapes due to, for example, manufacturing. For example, regions illustrated or described as flat may, typically, have rough and/or nonlinear features. Moreover, sharp angles illustrated may be rounded. Thus, the regions illustrated in the drawings are inherently schematic, and their shapes are not intended to depict the precise shape of a region and are not intended to limit the scope of the claims.

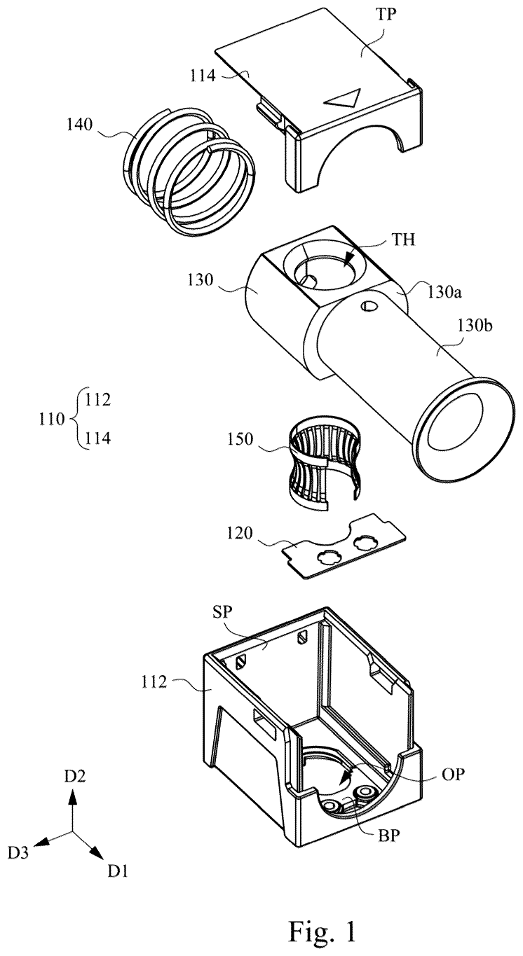

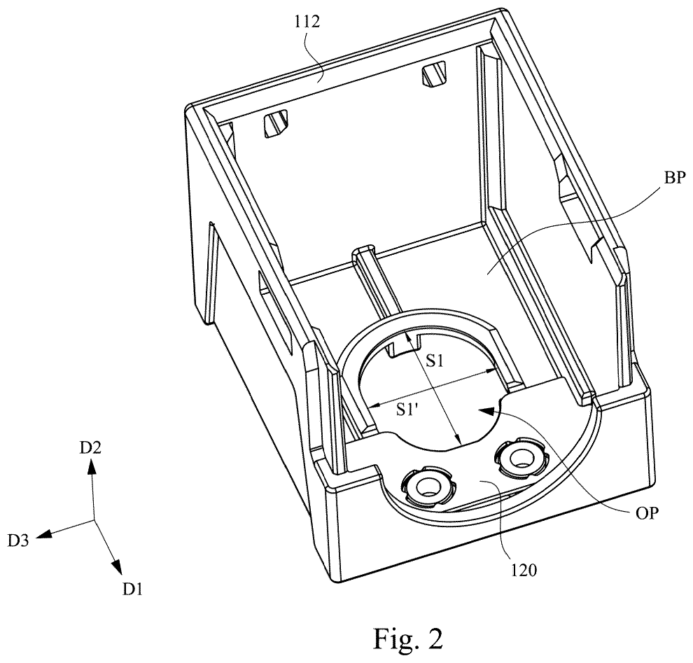

Reference is made to FIG. 1 and FIG. 2. FIG. 1 is an exploded view of an electrical connection device 10 according to some embodiments of the present disclosure. FIG. 2 is a perspective view of some components of the electrical connection device 10 after assembly.

As shown in FIG. 1, the electrical connection device 10 includes a housing 110, an engaging element 120, a connecting socket 130, an elastic element 140, and a conducting contact element 150. The engaging element 120, the connecting socket 130, the elastic element 140, and the conducting contact element 150 are partially or completely disposed in the housing 110.

In greater detail, the housing 110 has a bottom portion BP, a top portion TP, and a side portion SP connecting the bottom portion BP and the top portion TP, forming a substantially rectangular parallelepiped structure. The engaging element 120, the connecting socket 130, the elastic element 140, and the conducting contact element 150 are disposed between the bottom portion BP and the top portion TP of the housing 110.

As shown in FIG. 1 and FIG. 2, the bottom portion BP of the housing 110 has an opening OP. The opening OP is configured for an electrical connecting terminal (such as the electrical connecting terminal 20 and the electrical connecting terminal 30 shown in subsequent figures) to pass through. As such, the electrical connecting terminal enters the housing 110 to couple with the connecting socket 130. The connecting socket 130 and the housing 110 can move relatively along a lengthwise direction of the connecting socket 130 (i.e., the direction D1 shown in FIG. 1). In some embodiments, the opening OP has a dimension S1 along the lengthwise direction of the connecting socket 130. In some embodiments, the opening OP has a dimension S1′ along a width direction (i.e., the direction D3 shown in FIG. 2) that is perpendicular to the lengthwise direction of the connecting socket 130. In some embodiments, the shape of the opening OP is approximately an ellipse. For example, the dimension S1 along the lengthwise direction is greater than the dimension S1′ along the width direction, but this disclosure is not limited thereto. The side portion SP of the housing 110 has two outer surfaces that are opposite to each other in the direction D3. The side portion SP has slots on the two outer surfaces for users to hold the electrical connection device 10 and to lock and unlock the electrical connection device 10 with the electrical connecting terminal.

In some embodiments, in order to facilitate the assembly of the electrical connection device 10, the housing 110 may include a first portion 112 and a second portion 114 that may be mutually engaged. In some embodiments, the housing 110 is made of insulating materials.

As shown in FIG. 1, the engaging element 120 is at the bottom portion BP of the housing 110. The engaging element 120 may be a structure formed integrally with the housing 110, or an independent structure formed separately and then assembled with the housing 110. FIG. 2 illustrates the engaging element 120 assembled on the first portion 112 of the housing 110. As shown in FIG. 2, the engaging element 120 is coupled to the bottom portion BP of the housing 110. For example, the engaging element 120 may have holes for protruding structures of the bottom portion BP to fit into, so that the engaging element 120 is fixed on the housing 110. In addition, after the assembly is completed, the engaging element 120 has an edge substantially coincident with an inner edge of the opening OP. As a result, when the electrical connecting terminal enters the housing 110 and reaches a predetermined position, the engaging element 120 engages with the electrical connecting terminal (e.g., the engaging element 120 inserts into a notch of the electrical connecting terminal). In other words, in a projection along the direction D2, the engaging element 120 partially overlaps the opening OP.

In some embodiments, the engaging element 120 is made of metal materials such as steel to provide a higher retention force.

As shown in FIG. 1, the connecting socket 130 is coupled to the housing 110. In greater detail, the connecting socket 130 has a mating portion 130a and a connecting portion 130b that are connected to each other along the lengthwise direction of the connecting socket 130. The mating portion 130a is in the housing 110 and over the engaging element 120. The mating portion 130a has a mating hole TH. A direction of a central axis of the mating hole TH (i.e., the direction D2) is perpendicular to the lengthwise direction of the connecting socket 130. In some embodiments, the mating hole TH may be circular or elliptical. The mating hole TH may be a through hole with openings at both ends or a hole with an opening at one end and a closed bottom at the other end. However, this disclosure is not limited thereto. When the connecting socket 130 is disposed in the housing 110, the connecting portion 130b extends through an aperture of the housing 110 to the outside of the housing 110, and the mating hole TH at least partially overlaps the opening OP of the first portion 112. The aperture of the housing 110 may be formed on one side of the first portion 112 and the second portion 114 after they are mutually engaged (or latched together), so as to allow the connecting portion 130b to pass through. Alternatively, the aperture of the housing 110 may be formed on one sidewall of the side portion SP of the first portion 112 alone. The connecting portion 130b is configured to allow external cables to enter along the lengthwise direction (i.e., the direction D1) of the connecting socket 130 and be electrically connected therewith. In some embodiments, as shown in FIG. 1, the connecting portion 130b is a tubular structure for accommodating cables, but the disclosure is not limited thereto. In some embodiments, as shown in FIG. 1, a dimension of the mating portion 130a along the direction D3 is greater than a dimension of the connecting portion 130b along the direction D3. As such, after the assembly is completed, it is ensured that the mating portion 130a has an abutting surface to abut against an inner wall of the side portion SP of the housing 110 to prevent the mating portion 130a from falling out of the housing 110. In some embodiments, the connecting socket 130 is made of conductive materials.

As shown in FIG. 1, the elastic element 140 is coupled to the housing 110. In greater detail, after the assembly is completed, the elastic element 140 is between the mating portion 130a of the connecting socket 130 and the side portion SP of the housing 110 along the lengthwise direction (i.e., the direction D1) of the connecting socket 130. For example, the elastic element 140 is a spring. One end of the spring abuts against the mating portion 130a, and the other end of the spring abuts against the side portion SP. In addition, the elastic element 140 is at a side of the mating portion 130a that is away from the engaging element 120. After the electrical connection device 10 is assembled, the elastic element 140 is in a compressed state. That is, the elastic element 140 provides a restoring force to push the mating portion 130a toward the engaging element 120.

In some other embodiments, the engaging element 120 may be at the bottom portion BP and at a side of the mating portion 130a that is away from the connecting portion 130b along the lengthwise direction (i.e., the direction D1). In addition, the elastic element 140 and the connecting portion 130b may be at the same side of the mating portion 130a, and the elastic element 140 may be between the mating portion 130a and a corresponding sidewall of the side portion SP (i.e., the elastic element 140 may be at the side of the mating portion 130a that is away from the engaging element 120). The connecting portion 130b may also pass through the elastic element 140, so that the positioning of the elastic element 140 is more stable and may not be laterally offset due to external force during subsequent operations.

The conducting contact element 150 is disposed in the mating hole TH of the mating portion 130a. The conducting contact element 150 is configured to contact the mating portion 130a and an electrical connecting terminal subsequently inserted into the mating portion 130a, so as to increase the conductive area and current conducting capacity between the mating portion 130a and the electrical connecting terminal. For example, when the electrical connecting terminal inserts into the mating portion 130a, the conducting contact element 150 surrounds and contacts an outer wall of the electrical connecting terminal 20. At the same time, the conducting contact element 150 contacts an inner wall of the mating hole TH. In some embodiments, the conducting contact element 150 is made of conductive materials. The conducting contact element 150 may be a crown spring that is substantially annular.

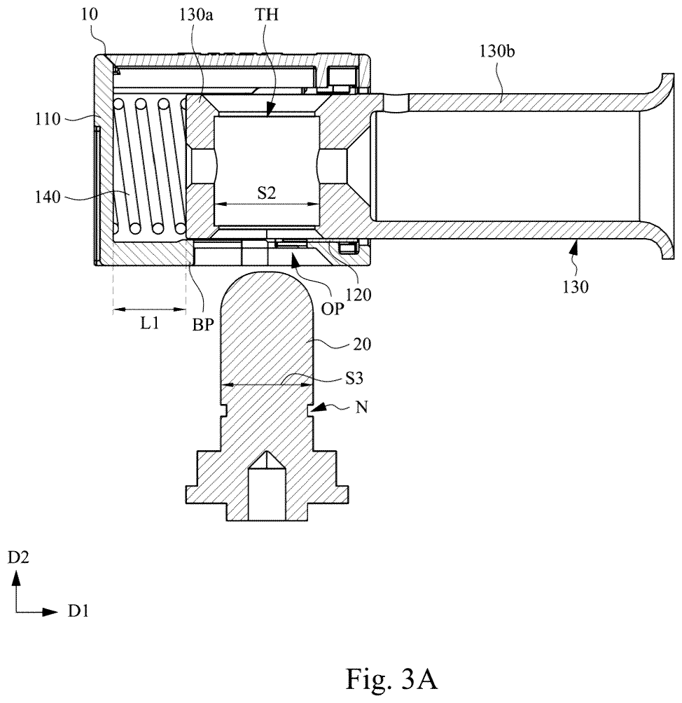

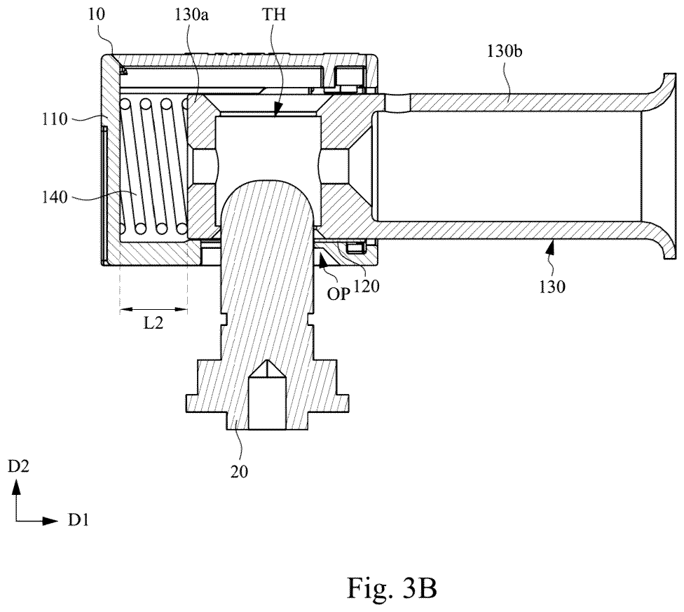

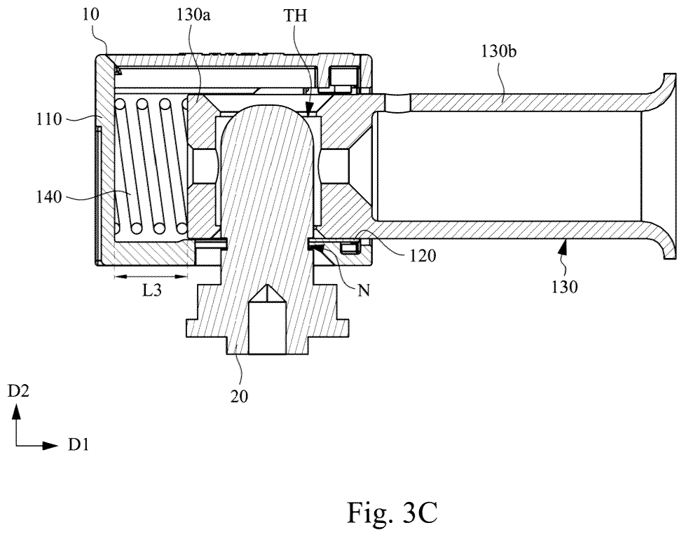

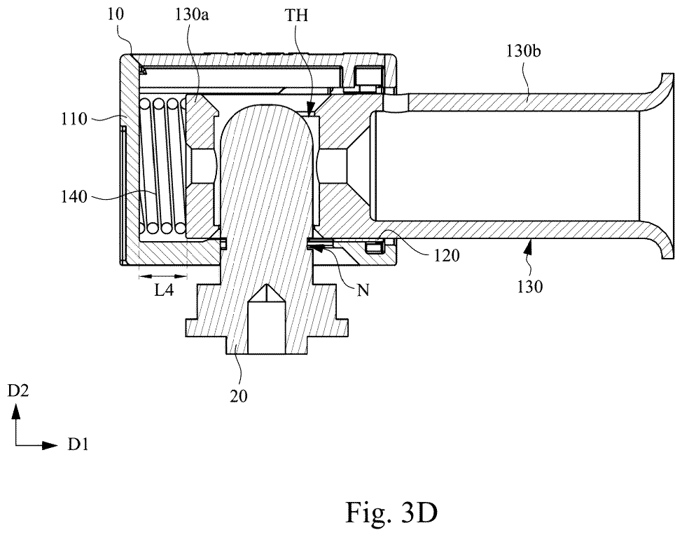

Reference is made to FIG. 3A to FIG. 3D. FIG. 3A is a cross-sectional view of the electrical connection device 10 assembled according to the configuration of FIG. 1 and the electrical connecting terminal 20 to be inserted. FIG. 3B is a cross-sectional view of the electrical connecting terminal 20 being partially inserted into the electrical connection device 10. FIG. 3C is a cross-sectional view of the electrical connecting terminal 20 being locked with the electrical connection device 10. FIG. 3D is a cross-sectional view of the electrical connecting terminal 20 being unlocked from the electrical connection device 10. It should be noted that the conducting contact element 150 is omitted in the cross-sectional views for the sake of simplicity.

First, as shown in FIG. 3A, after the electrical connection device 10 is assembled, the mating hole TH of the mating portion 130a is interconnected to the opening OP of the bottom portion BP of the housing 110. The mating hole TH has a dimension S2 along the direction D1. The dimension S2 of the mating hole TH is less than the dimension S1 of the opening OP (referring to FIG. 2). It should be noted that, as shown in FIG. 3A, in some embodiments, after the electrical connection device 10 is assembled, the mating hole TH of the mating portion 130a is partially blocked by the bottom portion BP of the housing 110. In other words, in a bottom-up view, the mating hole TH is not completely exposed through the opening OP. The mating hole TH has a chamfer at a side surface of the mating portion 130a facing the opening OP, so that a diameter of the mating hole TH gradually decreases to the dimension S2 from the outside to the inside. As such, the subsequent insertion of the electrical connecting terminal 20 may be guided.

On the other hand, as shown in FIG. 3A, the electrical connecting terminal 20 has a dimension S3 along the direction D1. The dimension S3 of the electrical connecting terminal 20 is less than the dimension S1 of the opening OP and slightly less than the dimension S2 of the mating hole TH. A dimension of one end (i.e., a front end for insertion) of the electrical connecting terminal 20 gradually and nonlinearly decreases along the direction D2. The elastic element 140 and the mating portion 130a are disposed along the direction D1. The elastic element 140 is between the mating portion 130a and a sidewall of the side portion SP. This design allows the connecting socket 130 to move relative to the housing 110 along the direction D1 according to the state of external force of the connecting socket 130 by pushing (compressing) the elastic element 140 when the electrical connecting terminal 20 passes through the opening OP and inserts partially or completely into the mating portion 130a. In addition, this design allows the electrical connecting terminal 20 to be locked when reaching a locking position (referring to FIG. 3C) and to be unlocked when leaving the locking position.

As shown in FIG. 3A, the electrical connecting terminal 20 has a notch N configured for the engaging element 120 to insert into. Although the notch N shown in FIG. 3A is a notch formed around the entire circumference of the outer wall of the electrical connecting terminal 20, the notch N may also be a notch only disposed on one side of the electrical connecting terminal 20. However, this disclosure is not limited thereto.

As aforementioned, when the electrical connection device 10 is assembled and the electrical connecting terminal 20 has not been inserted, the elastic element 140 is in a compressed state and exerts a force on the connecting socket 130. Therefore, an end of the mating portion 130a of the connecting socket 130 that is away from the elastic element 140 abuts against the side portion SP and causes the mating hole TH to be partially blocked by the bottom portion BP. At this point, an exposed dimension of the mating hole TH along the direction D1 is less than the dimension S3 of the electrical connecting terminal 20, and the elastic element 140 has a length L1 along the direction D1.

In practical applications, the electrical connecting terminal 20 is fixed on, for example, a printed circuit board (PCB). The users connect the electrical connection device 10 to the fixed electrical connecting terminal 20. As a result, in the following paragraphs, the electrical connecting terminal 20 is taken as a reference point for describing movement of components in the electrical connection device 10 relative to the electrical connecting terminal 20 during the locking and unlocking processes.

As shown in FIG. 3B, since the mating hole TH of the mating portion 130a may be partially blocked by the housing 110 and the exposed dimension along the direction D1 is less than the dimension S3 of the electrical connecting terminal 20 as aforementioned, the engaging element 120 and/or the housing 110 abuts against the electrical connecting terminal 20 and is pushed rightward during the insertion of the front end of the electrical connecting terminal 20 through the opening OP and gradually into the mating hole TH. As a result, the housing 110 moves to the right relative to the electrical connecting terminal 20 and the mating hole TH is completely exposed (or to an extent that the exposed dimension of the mating hole TH along the direction D1 is greater than or equal to the dimension S3 of the electrical connecting terminal 20). In this case, the elastic element 140 is further compressed along the direction D1. Thus, the elastic element 140 has a length L2 along the direction D1. The length L2 is less than the length L1.

Next, as shown in FIG. 3C, the electrical connecting terminal 20 enters the mating hole TH until the notch N of the electrical connecting terminal 20 is aligned with the engaging element 120. Since the elastic element 140 is always in a compressed state, the elastic element 140 applies a leftward force to the housing 110. Therefore, when the notch N of the electrical connecting terminal 20 is aligned with the engaging element 120, the restoring force of the elastic element 140 drives the housing 110 and the engaging element 120 to move to the left relative to the electrical connecting terminal 20. This action causes the engaging element 120 to insert into the notch N of the electrical connecting terminal 20, thereby locking the electrical connecting terminal 20 with the electrical connection device 10. At this point, the elastic element 140 has a length L3 along the direction D1 and is still in a compressed state. The length L3 is greater than the length L2.

As shown in FIG. 3D, when unlocking, the users only need to provide an external force to push the housing 110 rightward, so that the engaging element 120 is disengaged from the notch N of the electrical connecting terminal 20. Then, the electrical connection device 10 may be moved upward and the electrical connecting terminal 20 may be released. At this point, the compression amount of the elastic element 140 increases. In some embodiments, for unlocking, the compression amount must be increased by at least about 0.5 mm. That is, the additional compression amount required to unlock is at least about 0.5 mm. Meanwhile, the maximum compression amount is about 2.2 mm to prevent the elastic element 140, the connecting socket 130, and the electrical connecting terminal 20 from fatigue or damage due to excessive force during repeated locking and unlocking. For example, when the compression amount is at a maximum value, the position of the housing 110 relative to the electrical connecting terminal 20 is as shown in FIG. 3D. At this point, the elastic element 140 has a length L4 along the direction D1. A difference between the length L4 and the length L3 is less than about 2.2 mm, so that the force applied by the elastic element 140 to the connecting socket 130 and the electrical connecting terminal 20 during the locking and unlocking processes is less than about 9 Newtons (N).

In some other embodiments, a dimension of the opening OP along the lengthwise direction of the connecting socket 130 is less than a dimension of the opening OP along the width direction of the connecting socket 130. The engaging element 120 may be at the bottom portion BP and at a side of the mating portion 130a along the width direction (i.e., the direction D3). In addition, the elastic element 140 may be between an oppose side of the mating portion 130a and a corresponding sidewall of the side portion SP (i.e., the elastic element 140 may be at the side of the mating portion 130a that is away from the engaging element 120) and is compressed along the width direction when the engaging element 120 inserts into the notch N of the electrical connecting terminal 20. The connecting socket 130 and the housing 110 can move relatively along the width direction of the connecting socket 130 (i.e., the direction D3) during the locking and unlocking processes.

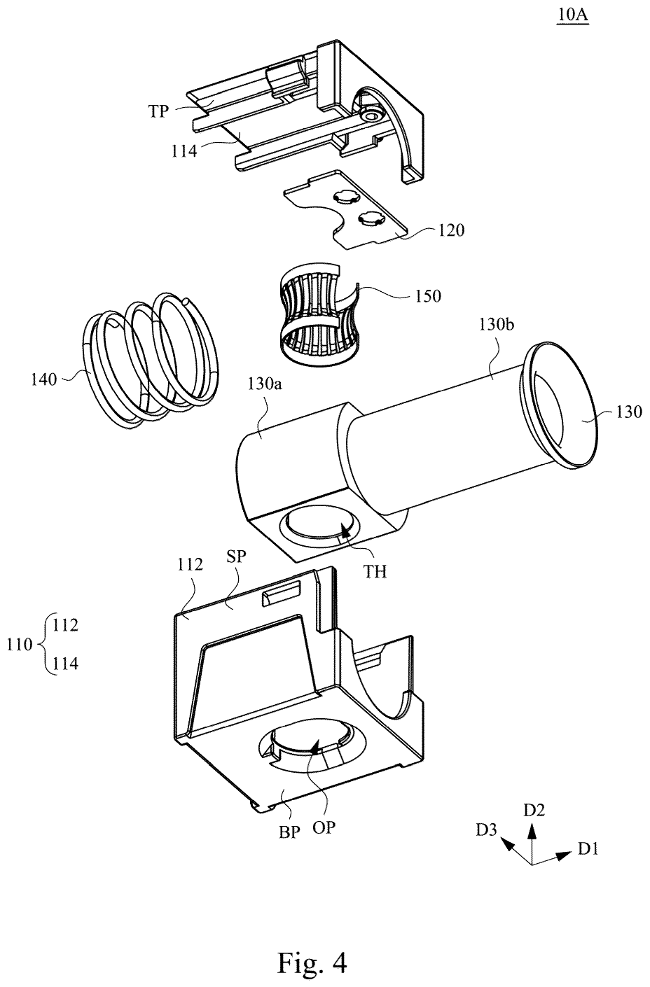

Reference is made to FIG. 4 and FIG. 5. FIG. 4 is an exploded view of an electrical connection device 10A according to some embodiments of the present disclosure. FIG. 5 is a perspective view of the second portion 114 of the housing 110 and the engaging element 120 of the electrical connection device 10A after assembly. The difference between the electrical connection device 10A and the electrical connection device 10 is that the engaging element 120 of the electrical connection device 10A is disposed over the connecting socket 130. The engaging element 120 is coupled to the top portion TP of the housing 110. In a projection along the direction D2, the engaging element 120 partially overlaps the opening OP. For example, the engaging element 120 may have holes for protruding structures of the top portion TP to fit into. The engaging element 120 has an arc-shaped edge in the overlapped portion with the opening OP. As a result, when the electrical connecting terminal enters the housing 110 and reaches a predetermined position, the engaging element 120 can insert into a notch along the contour of the electrical connecting terminal. It should be noted that the components of the electrical connection device 10A and the electrical connection device 10 may be structurally identical, with the only difference being the assembly position of the engaging element 120.

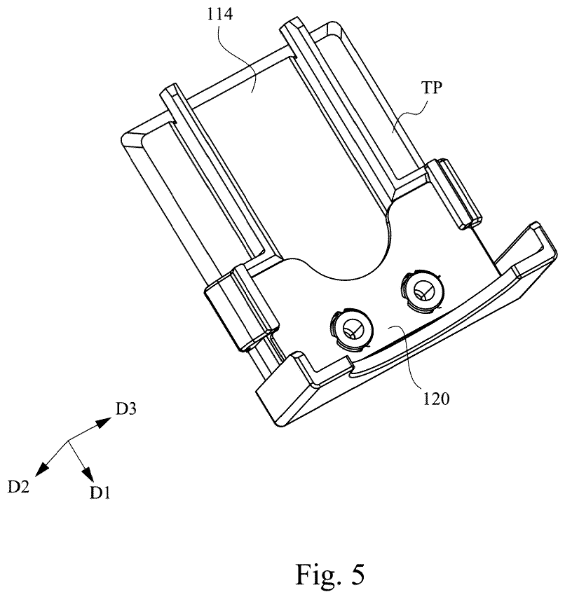

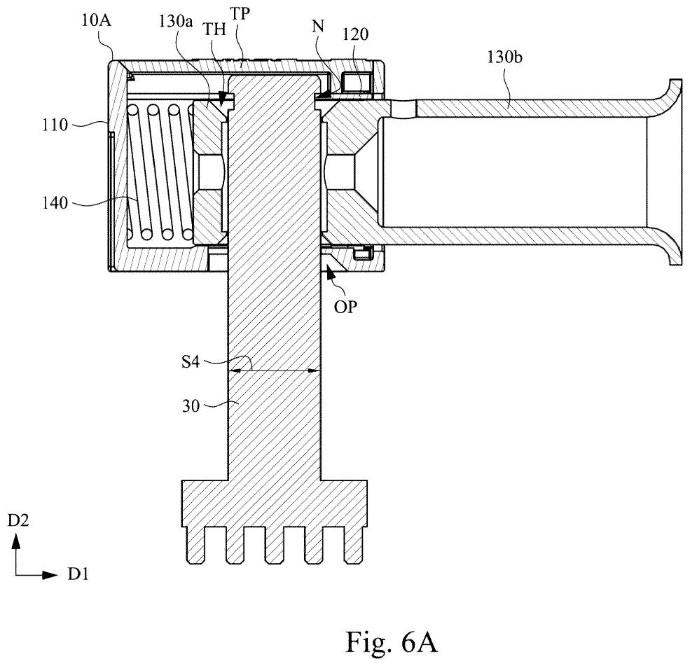

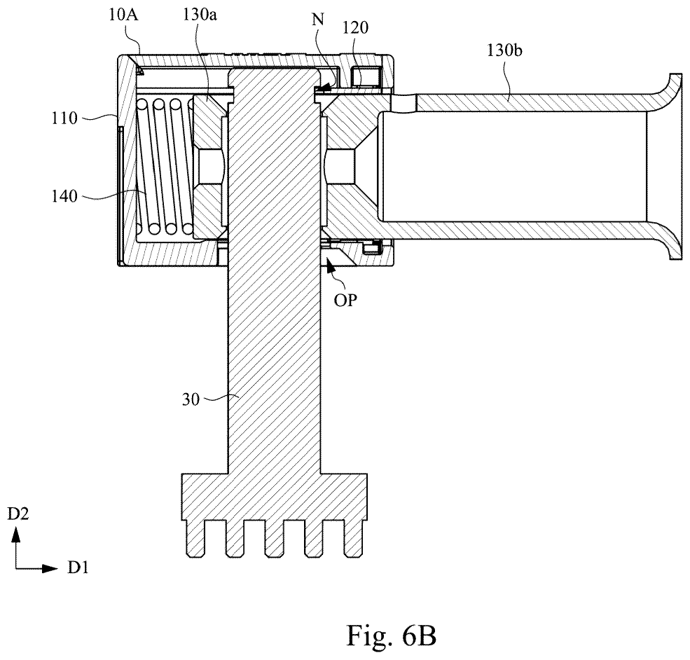

Reference is made to FIG. 6A to FIG. 6B. FIG. 6A is a cross-sectional view of the electrical connecting terminal 30 being locked with the electrical connection device 10A. FIG. 6B is a cross-sectional view of the electrical connecting terminal 30 being unlocked from the electrical connection device 10A. Similarly, for the sake of simplicity, the conducting contact element 150 is omitted in the cross-sectional views.

One of the differences between the electrical connecting terminal 30 and the aforementioned electrical connecting terminal 20 is the position of the notch N. The notch N of the electrical connecting terminal 30 is disposed closer to the top end of the electrical connecting terminal 30. In addition, the bottom end of the electrical connecting terminal 30 has a plurality of pins. The pins are columnar for being inserted or press-fitted onto the printed circuit board to conduct a larger current.

The electrical connecting terminal 30 has a dimension S4 along the direction D1. Similarly, the dimension S4 of the electrical connecting terminal 30 is less than the dimension S1 of the opening OP (referring to FIG. 2) and slightly less than the dimension S2 of the mating hole TH (referring to FIG. 3A). As such, the housing 110 is allowed to move along the direction D1 relative to the electrical connecting terminal 30 during the mating process to achieve the effect of locking and unlocking.

As shown in FIG. 6A, the electrical connecting terminal 30 completely passes through the opening OP and the mating hole TH until the notch N exposes from the mating hole TH and the engaging element 120 inserts into the notch N of the electrical connecting terminal 30. As shown in FIG. 6A, there is a gap between the engaging element 120 and the top portion TP of the housing 110 along the direction D2. Therefore, after the engaging element 120 inserts into the notch N of the electrical connecting terminal 30, the top end of the electrical connecting terminal 30 may be accommodated between the engaging element 120 and the top portion TP of the housing 110.

As shown in FIG. 6B, when unlocking, the users provide an external force to push the housing 110 rightward, so that the engaging element 120 is disengaged from the notch N of the electrical connecting terminal 30. Then, the electrical connection device 10A may be released from the electrical connecting terminal 30. Similarly, the additional compression amount of the elastic element 140 required for unlocking is between about 0.5 mm and about 1.7 mm to provide sufficient displacement to disengage the engaging element 120 from the notch N as well as prevent the elastic element 140 and the electrical connecting terminal 30 from being damaged due to excessive force during repeated locking and unlocking processes.

In the electrical connection device 10 and the electrical connection device 10A, the engaging element 120 is disposed at a side of the mating portion 130a that is away from the elastic element 140 along the direction D1. In some other embodiments, the engaging element and the elastic element may be disposed at the same side of the mating portion 130a.

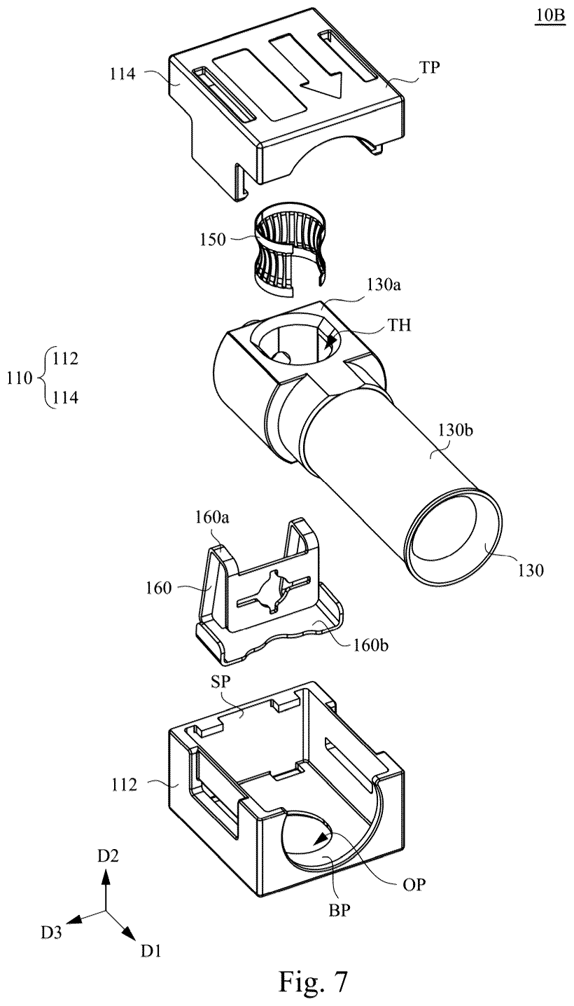

For example, reference is made to FIG. 7. FIG. 7 is an exploded view of an electrical connection device 10B according to some other embodiments of the present disclosure. An elastic piece 160 of the electrical connection device 10B includes an elastic element 160a and an engaging element 160b. The elastic element 160a is approximately inverted U-shape. A bottom portion of the elastic element 160a is connected to the engaging element 160b. For example, the elastic element 160a may include a board and two elastic arms. The two elastic arms are approximately inverted L-shaped. Top portions of the two elastic arms are connected to a top side of the board, and bottom portions of the two elastic arms are extended and connected to the engaging element 160b.

After the electrical connection device 10B is assembled, the elastic piece 160 is between the mating portion 130a and the side portion SP of the housing 110 along the lengthwise direction (i.e., the direction D1) of the connecting socket 130. The elastic piece 160 is at a side of the mating portion 130a that is away from the connecting portion 130b.

It should be noted that the detailed features of the first portion 112 and the second portion 114 of the housing 110 of the electrical connection device 10B and the first portion 112 and the second portion 114 of the housing 110 of the electrical connection device 10 may be slightly different. However, the housing 110 of the electrical connection device 10B and the housing 110 of the electrical connection device 10 are both approximately rectangular parallelepiped structures, with an opening OP at the bottom portion BP for the electrical connecting terminal to pass through and an aperture at the side portion SP for the connecting portion 130b of the connecting socket 130 to extend to the outside of the housing 110.

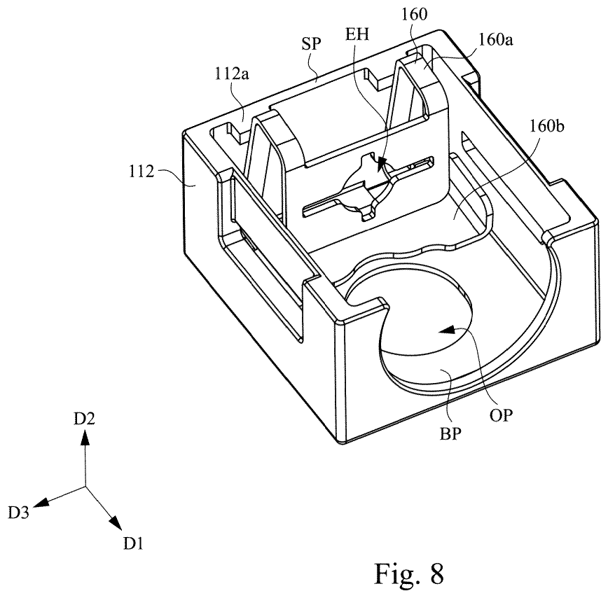

Reference is made to FIG. 8. FIG. 8 is a perspective view of the first portion 112 of the housing 110 and the elastic piece 160 of the electrical connection device 10B after assembly according to some other embodiments of the present disclosure. The elastic piece 160 is coupled to the first portion 112. In greater detail, the engaging element 160b of the elastic piece 160 is disposed over the bottom portion BP. The engaging element 160b has an edge disposed along an inner edge of the opening OP and configured to insert into the notch of the electrical connecting terminal. Similar to the electrical connection device 10, a dimension of the opening OP of the electrical connection device 10B along a lengthwise direction (i.e., the direction D1) may be greater than a dimension of the opening OP along a width direction (i.e., the direction D3). Meanwhile, the side portion SP has protrusions 112a protruding inwardly and is configured to abut against the elastic element 160a of the elastic piece 160. In addition, the elastic element 160a has an engaging hole EH (for example, on the board of the elastic element 160a) configured to be coupled with the connecting socket 130.

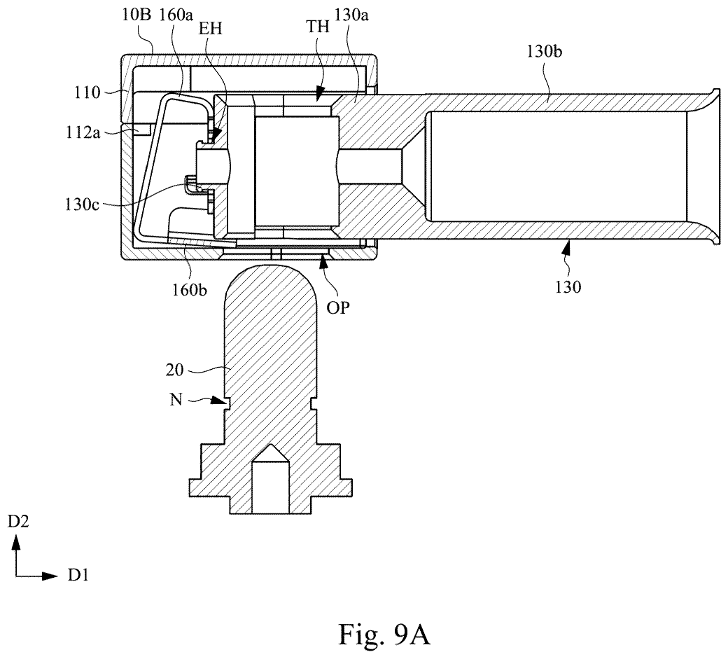

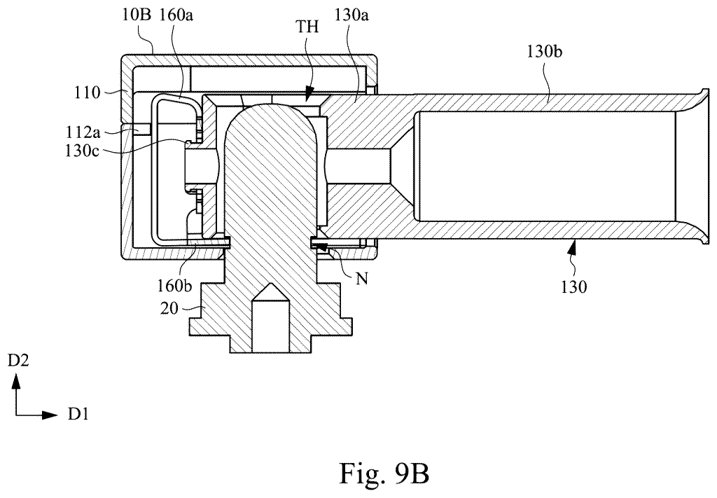

Reference is made to FIG. 9A to FIG. 9B. FIG. 9A is a cross-sectional view of the electrical connection device 10B assembled according to the configuration of FIG. 7 and the electrical connecting terminal 20. FIG. 9B is a cross-sectional view of the electrical connecting terminal 20 being locked with the electrical connection device 10B. Similarly, for the sake of simplicity, the conducting contact element 150 is omitted in the cross-sectional views.

As shown in FIG. 9A, after the electrical connection device 10B is assembled, the engaging hole EH of the elastic element 160a is coupled to an engaging portion 130c (e.g., a flange) of the connecting socket 130. In addition, the protrusions 112a protrude toward the connecting socket 130, and the elastic element 160a is between the protrusions 112a and the connecting socket 130. It should be noted that at this point, the elastic element 160a may be in a relaxed state and not compressed or may be slightly compressed.

As shown in FIG. 9B, the electrical connecting terminal 20 enters the mating hole TH, so that the connecting socket 130 moves to the left relative to the housing 110, thereby compressing the elastic arms of the elastic element 160a. The protrusions 112a therefore abut against the elastic arms of the elastic element 160a and serve as lever fulcra, so that the engaging element 160b moves rightward and then inserts into the notch N of the electrical connecting terminal 20. Thereby, the locking is completed. In this state, the engaging element 160b is partially below the mating portion 130a of the connecting socket 130.

To unlock, the users only need to provide an external force to push the housing 110 leftward or pull the connecting socket 130 rightward, so that the engaging element 160b is disengaged from the notch N of the electrical connecting terminal 20. Then, the electrical connection device 10B may be released from the electrical connecting terminal 20.

According to the foregoing recitations of the embodiments of the disclosure, it may be seen that in the electrical connection device of some embodiments of the present disclosure, the elastic element is disposed between the connecting socket and the housing along the lengthwise direction of the connecting socket, and the engaging element is in the housing and configured to insert into the notch of the electrical connecting terminal. Therefore, the electrical connection device and the electrical connecting terminal can be locked and unlocked by moving the housing of the electrical connection device relative to the electrical connecting terminal along the lengthwise direction of the connecting socket. Compared with common electrical connection devices, mating and assembly of the electrical connection device of some embodiments of the present disclosure are facilitated, reducing the time and labor consumed in installation and maintenance, which in turn reduces costs.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure covers modifications and variations of this disclosure provided they fall within the scope of the following claims.

What is claimed is:

1. An electrical connection device, comprising:
a housing having a bottom portion, a top portion, and a side portion connecting the bottom portion and the top portion, wherein the bottom portion has an opening configured for an electrical connecting terminal to pass through;
a connecting socket coupled to the housing and having a mating portion and a connecting portion connected to each other, wherein the mating portion is in the housing and has a mating hole, and the mating hole is interconnected to the opening of the bottom portion of the housing;
a conducting contact element in the mating hole of the connecting socket;
an elastic element between the mating portion of the connecting socket and the side portion of the housing; and
an engaging element coupled to the housing and configured to insert into a notch of the electrical connecting terminal.

2. The electrical connection device of claim 1, wherein the engaging element is at a side of the mating portion that is away from the elastic element.

3. The electrical connection device of claim 2, wherein the engaging element is over the connecting socket.

4. The electrical connection device of claim 2, wherein the connecting socket is over the engaging element.

5. The electrical connection device of claim 1, wherein the elastic element is connected to the engaging element.

6. The electrical connection device of claim 5, wherein the side portion of the housing has a protrusion protruding toward the connecting socket, and the protrusion is configured to abut against the elastic element when the engaging element inserts into the notch of the electrical connecting terminal.

7. The electrical connection device of claim 1, wherein the elastic element has an engaging hole, and the connecting socket has an engaging portion coupled to the engaging hole of the elastic element.

8. The electrical connection device of claim 1, wherein the elastic element is configured to be compressed along a lengthwise direction of the connecting socket when the engaging element inserts into the notch of the electrical connecting terminal.

9. The electrical connection device of claim 8, wherein a dimension of the electrical connecting terminal along the lengthwise direction is less than a dimension of the opening of the housing along the lengthwise direction.

10. The electrical connection device of claim 9, wherein the connecting portion is configured for a cable to enter along the lengthwise direction and be electrically connected.

11. The electrical connection device of claim 1, wherein the elastic element is configured to be compressed along a width direction of the connecting socket when the engaging element inserts into the notch of the electrical connecting terminal.

12. The electrical connection device of claim 1, wherein the engaging element is a structure formed integrally with the housing.

13. An electrical connection device, comprising:
a housing having a bottom portion, a top portion, and a side portion connecting the bottom portion and the top portion, wherein the bottom portion has an opening configured for an electrical connecting terminal to pass through;
a connecting socket coupled to the housing in a relatively movable manner, wherein the connecting socket has a mating hole, and the mating hole is interconnected to the opening of the bottom portion of the housing;
a conducting contact element in the mating hole of the connecting socket; and
an engaging element coupled to the housing and configured to engage the electrical connecting terminal when the electrical connecting terminal inserts into the mating hole.

14. The electrical connection device of claim 13, wherein the connecting socket comprises a mating portion and a connecting portion, and the mating portion is in the housing and connected to the connecting portion along a lengthwise direction of the connecting socket.

15. The electrical connection device of claim 14, further comprising an elastic element between the mating portion and the side portion.

16. The electrical connection device of claim 15, wherein the elastic element is connected to the engaging element, and the side portion has a protrusion configured to abut against the elastic element.

17. The electrical connection device of claim 14, wherein a dimension of the opening along the lengthwise direction is greater than a dimension of the opening along a direction that is perpendicular to the lengthwise direction.

18. The electrical connection device of claim 14, wherein a dimension of the opening along the lengthwise direction is less than a dimension of the opening along a direction that is perpendicular to the lengthwise direction.

19. The electrical connection device of claim 13, wherein in a projection along a central axis of the mating hole, the engaging element partially overlaps the opening.
